(19) United States
(12) Patent Application Publication
(10) Pub. No.: US 2009/0274185 A1
(43) Pub. Date: Nov. 5, 2009

(54) Laser Drive Amplifier

(75) Inventor: Mark Champion, Kenmore, WA (US)

Correspondence Address: MICROVISION, INC., 6222 185TH AVENUE NE, REDMOND, WA, 98052, US

(73) Assignee: MICROVISION, INC., Redmond, WA (US)

(21) Appl. No.: 12/114,620

(22) Filed: May 2, 2008

(51) Int. Cl. H01S 3/00

(52) U.S. Cl. 372/38.02

(57) ABSTRACT

A laser drive amplifier apparatus includes a device (e.g., Class A amplifier or digital-to-analog converter) driving a laser diode. A programmable switching power supply provides a power supply voltage for the device driving the laser diode. One or more voltages on the device are measured, and the power supply voltage is changed in response thereto. The power supply voltage may be updated for each video line, video frame, or zone in a video display.

### FIELD

The present invention relates generally to amplifiers, and more specifically to amplifiers suitable to drive laser light sources.

### BACKGROUND

Direct modulation of laser diodes for video applications is typically performed using Class A amplifiers in which a series pass transistor varies the current supplied to the laser diode. Class A amplifiers are typically not very power efficient because much of the system power is dissipated by the series transistor. This inefficiency results in wasted power consumption which increases heat and reduces battery life.

The power wasted in a Class A amplifier is directly related to the power supply voltage. Normally this voltage is designed to be as low as possible while still being high enough to deliver the maximum current to the laser diode to meet the system's required light output under all conditions. For example, if a given laser diode requires 5 Volts and 200 milliamps (mA) for its peak light level, the power supply might be designed to output 6 Volts. In this case, the system would consume 1.2 Watts (6V×0.2 A) of power and the transistor would dissipate only 200 milliwatts (mW) ((6V-5V)×0.2 A) of power. If a 10 Volt power supply is used, the system would consume 2 Watts (10V×0.2 A) of power and the transistor would dissipate 1 Watt ((10V-5V)×0.2 A) for the same laser diode operating point. In this example, a power supply that outputs more than 6 Volts merely requires the pass transistor to dissipate more power. A power supply that outputs less than about 5.5 Volts will not provide enough headroom or regulator margin to allow the transistor to deliver the required 5 Volts, 200 mA to the laser diode load.

The power supply voltage must be carefully chosen to maximize the efficiency of the Class A amplifier. In a conservative design the supply must be chosen to meet the requirements of the least efficient laser diode and the least efficient version of all other performance limiting components (fiber coupler, etc.). This normally results in wasted power in a typical unit when operating at full power (brightness). And it also means wasted power in all units when operating at less than full power. Wasted power limits battery life and is a significant source of heat that can be difficult to manage.

### BRIEF DESCRIPTION OF THE DRAWINGS

FIG. 1 shows a laser drive amplifier apparatus with a peak follower circuit;

FIG. 2 shows a laser drive amplifier apparatus with a peak detector circuit;

FIG. 3 shows a laser drive amplifier apparatus with a minimum voltage detector;

FIG. 4 shows a laser drive amplifier apparatus with a detector;

FIG. 5 shows a laser drive amplifier apparatus with a voltage drop measurement circuit;

FIG. 6 shows a laser drive amplifier apparatus with memory;

FIGS. 7 and 8 show display areas having zones;

FIG. 9 shows a laser drive amplifier apparatus with a First-In-First-Out (FIFO) memory;

FIG. 10 shows a laser drive amplifier apparatus with a FIFO memory and a minimum voltage detector;

FIG. 11 shows a color laser projection apparatus;

FIG. 12 shows a mobile device in accordance with various embodiments of the present invention; and

FIG. 13 shows a flowchart in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

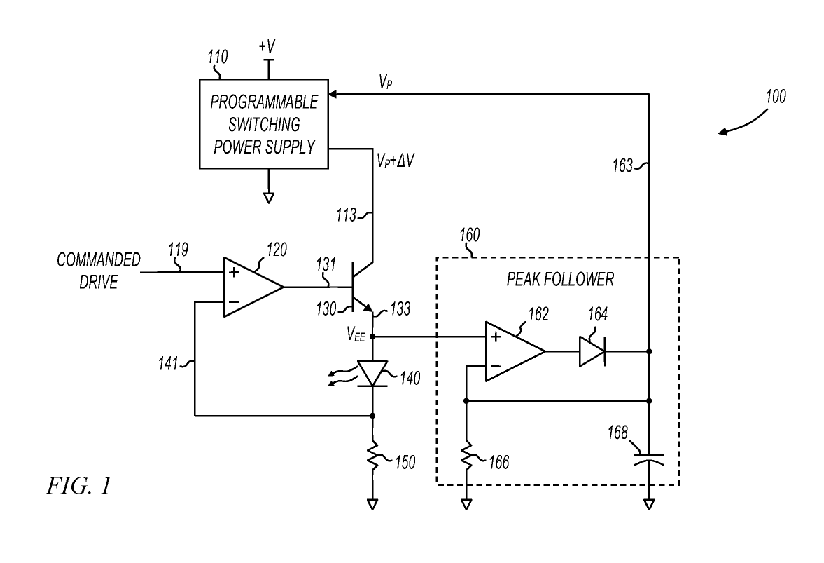

FIG. 1 shows a laser drive amplifier apparatus with a peak follower circuit. Apparatus 100 includes programmable switching power supply 110, Class A amplifier transistor 130, laser diode 140, resistor 150, amplifier 120, and peak follower circuit 160. In operation, programmable switching power supply 110 provides a power supply voltage to the collector of transistor 130 on node 113. The emitter node 133 of transistor 130 is coupled to laser diode 140. Transistor 130 provides a drive current to laser diode 140 in response to a drive voltage on the base node 131 of transistor 130. Laser diode 140 emits light in response to the voltage on emitter node 133 and the current provided by transistor 130.

A commanded drive value is provided to amplifier 120 on node 119. The commanded drive value commands a specific voltage or current drive to the load. In embodiments represented by FIG. 1, the commanded drive value is an analog voltage, although this is not a limitation of the present invention. For example, the commanded drive value may be provided as a digital value, and apparatus 100 may include a digital-to-analog converter (DAC). The commanded drive value represents a desired laser diode output luminance for a particular amount of time (e.g., one pixel). When the commanded drive value represents one pixel of a video display, the commanded value changes at the pixel rate, which can be at rates significantly above 100 Megahertz (MHz). The Class A amplifier configuration is chosen to drive laser diode 140 in part because of the high bandwidth capabilities of Class A amplifiers.

Amplifier 120 receives the commanded drive value on node 119, and also receives feedback on node 141. The feedback on node 141 represents the actual current through laser diode 140. Amplifier 120 drives base node 131 of transistor 130 in response to the commanded drive value and the feedback. The feedback loop formed by amplifier 120, transistor 130, laser diode 140, and resistor 150 function to match the commanded drive value with the actual current through laser diode 140. In some embodiments, additional components are included to compensate for nonlinearities in laser diode 140. For example, some embodiments include analog-to-digital converters (ADCs), DACs, and digital look-up tables to map commanded luminance values to voltages and/or currents. These components and others have been intentionally omitted from FIG. 1 for clarity.

Peak follower circuit 160 includes amplifier 162, diode 164, resistor 166, and capacitor 168. The output of amplifier 162 is coupled to diode 164. One input of amplifier 162 is coupled to emitter node 133 of transistor 130. The other input of amplifier 162 is coupled to diode 164 and an RC circuit that include resistor 166 and capacitor 168.

Peak follower circuit 160 functions by monitoring the peak voltage (V_{P}) that appears at the emitter of the series pass transistor (V_{EE}) during some interval (e.g. one video frame). The output (node 163) of peak follower circuit 160 provides switching power supply 110 with the peak voltage value V_{P}. In response, switching power supply 110 outputs V_{P} plus a sufficient voltage margin, ΔV (e.g., about 0.5 Volts) to guarantee proper operation of transistor 130. The RC circuit within peak follower circuit 160 provides a relaxation mechanism that allows the power supply voltage to decay whenever V_{EE} decreases for some time interval. This time interval can be set to any value by modifying the RC time constant provided by resistor 166 and capacitor 168. For example, the RC time constant may correspond to less than one video frame (e.g., a few milliseconds), more than one video frame (e.g., hundreds of milliseconds, a second, or longer), or any value in between.

Programmable switching power supply 110 produces a power supply voltage for transistor 130 in response to the output of peak detector circuit 160. Programmable switching power supply 110 may be any type of switching power supply. For example, programmable switching power supply 110 may be a pulse width modulating (PWM) power supply switching at any frequency. Switching power supplies are generally known in the art, and the various embodiments of the present invention are not limited by the implementation details of programmable switching power supply 110.

In some embodiments, programmable switching power supply 110 is capable of sourcing current but not sinking current. Some switching supplies will sink current if they detect the output voltage is too high. They do this to maintain the voltage within some narrow tolerance. However in this application, when transitioning from a high voltage requirement zone to a low voltage requirement zone, there is no benefit in sinking current to reduce the voltage and unnecessary current sinking is a waste of power. Any excessive voltage will not affect amplifier performance. Excessive charge is better left in the switching supply's output capacitor for use by the amplifier rather than sinking it to ground.

In operation, peak follower circuit 160 automatically sets the output voltage (V_{P}+ΔV) of the switching power supply to a voltage designed to increase efficiency of the Class A amplifier. This doesn't necessarily save power when operating at maximum power (high laser brightness), but whenever the system operates at lower power levels, higher power efficiency is attained. In addition, peak follower circuit 160 compensates for other circuit variations, such as differences in laser diode characteristics as a function of process and temperature.

Peak follower circuit 160 is shown providing a feedback voltage equal to the peak emitter voltage V_{P}. In some embodiments, the peak follower circuit feeds back a different voltage. For example, peak follower circuit 160 may include an offset mechanism such that the voltage fed back to switching power supply 110 is equal to V_{P}+ΔV. In these embodiments, switching power supply 110 may use the voltage fed back directly as a reference voltage.

Class A amplifier transistor 130 is shown as a bipolar junction transistor (BJT), although this is not a limitation of the present invention. Any device suitable to provide current to a laser diode may be substituted therefor and is considered equivalent. For example, a field effect transistor (FET) such as a junction FET (JFET) or metal oxide semiconductor FET (MOSFET) may be utilized as the Class A amplifier transistor without departing from the scope of the present invention.

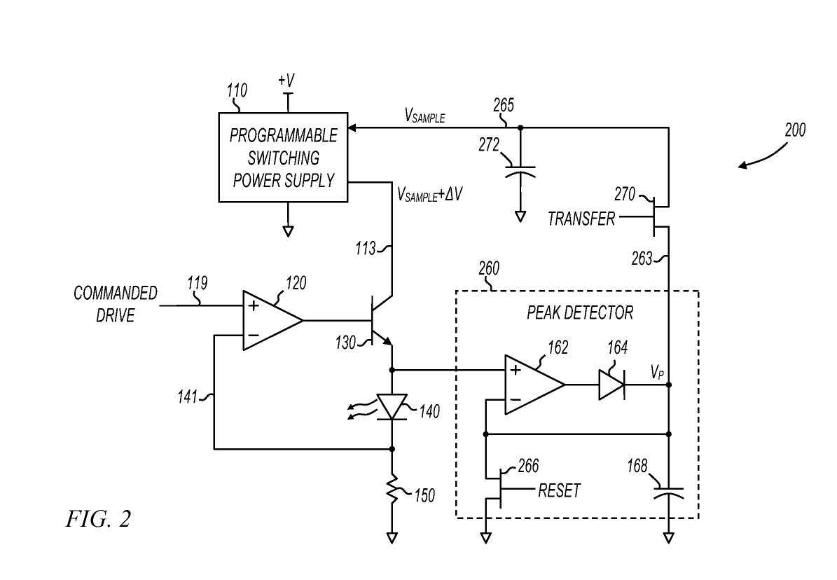

FIG. 2 shows a laser drive amplifier apparatus with a peak detector circuit. Apparatus 200 includes programmable switching power supply 110, transistor 130, laser diode 140, resistor 150, and amplifier 120, all of which are described above with reference to FIG. 1. Apparatus 200 also includes peak detector circuit 260, transistor 270, and capacitor 272.

Transistor 270 includes a gate node that is driven by a TRANSFER signal. When the TRANSFER signal is driven high, transistor 270 turns on and the output voltage V_{P} of peak detector circuit on node 263 is sampled onto node 265 and capacitor 272 as V_{SAMPLE}. Programmable switching power supply 110 receives V_{SAMPLE} and provides the power supply voltage V_{SAMPLE}+ΔV to the collector of Class A amplifier transistor 130.

Peak detector circuit 260 includes amplifier 160, diode 164, capacitor 168 and transistor 266. Peak detector circuit 260 is similar to peak follower circuit 160 (FIG. 1) with the exception of transistor 266. In operation, peak detector circuit 260 detects the peak emitter voltage V_{P}, and stores it on capacitor 168. Transistor 266 has a gate node driven by a RESET signal that when asserted turns on transistor 266, dumping any charge on capacitor 168 and resetting the voltage on node 263 to be substantially zero.

In operation, the peak voltage V_{P} is sampled onto capacitor 272 periodically, and peak detector circuit 260 is also reset periodically. For example, in some embodiments, the peak voltage is detected over an interval (e.g., a video frame), and then TRANSFER is asserted long enough to sample the peak voltage. Once sampled, V_{P} can be reset to zero by asserting RESET. The sampled voltage V_{SAMPLE} is then used to set the switching power supply's output voltage for the next time interval (e.g., next video frame). This process can be continually repeated for each successive time interval.

In video applications, and depending on time constants of the system, it may take one or two video frames for the system to respond fully when transitioning from a low brightness image to a high brightness image. These one or two frames may be required to elevate the peak detector's output and have the switching supply respond. This is typically not a problem with most video applications because human users do not typically notice the delay.

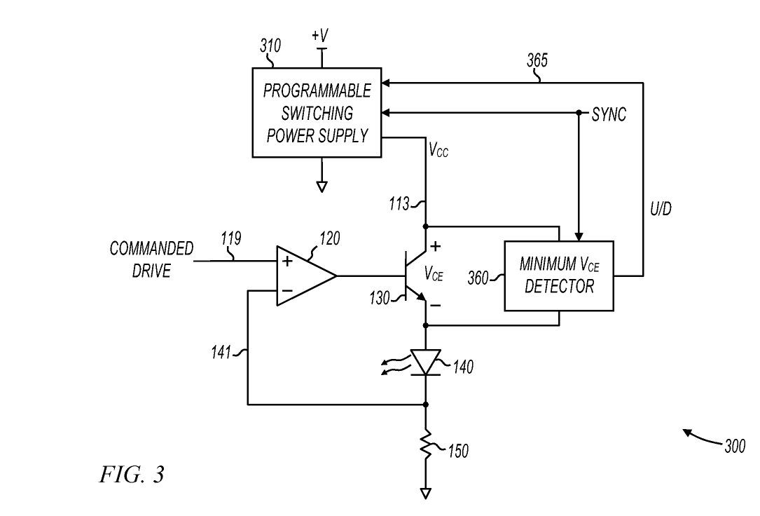

FIG. 3 shows a laser drive amplifier apparatus with a minimum voltage detector. Apparatus 300 includes Class A amplifier transistor 130, laser diode 140, resistor 150, and amplifier 120, all of which are described above with reference to earlier figures. Apparatus 300 also includes minimum voltage detector 360 and programmable switching power supply 310. Programmable switching power supply 310 differs from programmable switching power supply 110 (FIGS. 1, 2) in that power supply 310 is responsive to an up/down (U/D) signal rather than a peak voltage signal V_{P}. Minimum voltage detector 360 is coupled to the collector and emitter of transistor 130 and measures the collector-to-emitter voltage V_{CE}.

In operation, minimum voltage detector 360 notifies power supply 310 if V_{CE} falls below some threshold (e.g., 0.5 Volts). Minimum voltage detector 360 asserts U/D to command the power supply to increase the power supply voltage, and deasserts U/D to command the power supply to decrease the power supply voltage. Programmable switching power supply 310 may increase or decrease the power supply voltage by a fixed increment or a variable increment.

In some embodiments, programmable switching power supply 310 samples the U/D signal periodically, and minimum voltage detector 360 updates the U/D signal periodically. For example, the SYNC signal may be periodically asserted to cause U/D to be updated and sampled. The period between assertions of the SYNC signal may be related to a video frame. For example, the SYNC signal may be asserted once for each video frame in a series of video frames. Also for example, the SYNC signal may be asserted once for each video line in a video frame. If, during the period, V_{CE} dropped below the threshold, U/D is asserted to command the power supply to increase the power supply voltage. If, during the period, V_{CE} did not drop below the threshold, U/D is deasserted to command the power supply to decrease the power supply voltage.

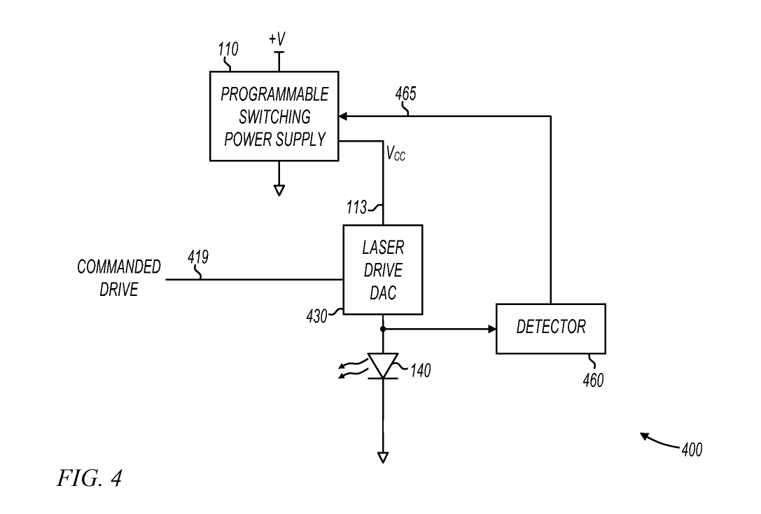

FIG. 4 shows a laser drive amplifier apparatus with a detector. Apparatus 400 includes programmable switching power supply 110 and laser diode 140, which are described above with reference to earlier figures. Apparatus 400 also includes laser drive digital-to-analog converter (DAC) 430 and detector 460.

In operation, laser drive DAC 430 receives a commanded drive value on node 419, and produces a current to drive laser diode 140. In some embodiments, the commanded drive value on node 419 includes multiple bits. For example, node 419 may include eight separate conductors to carry eight bits of drive data. In some embodiments, laser drive DAC 430 includes multiple Class A amplifier transistors coupled in parallel, with each transistor being responsive to one digital bit. In other embodiments, a lower power DAC is used to convert the digital commanded drive to a voltage value which then drives a single Class A amplifier transistor.

Detector 460 detects an output voltage of laser drive DAC 430. Detector 460 may include a peak follower circuit such as circuit 160 (FIG. 1), a peak detector circuit such as circuit 260 (FIG. 2), or the like. In some embodiments, detector 460 detects a peak voltage over a time period and provides the peak voltage information to programmable switching power supply 110. Programmable switching power supply then provides a power supply voltage V_{CC} to the laser drive DAC.

Similar to Class A amplifier transistor 130 (FIGS. 1-3), laser drive DAC 430 requires at least a minimum voltage drop to operate correctly. As described above with reference to previous figures, when the power supply voltage is increased beyond the voltage necessary to maintain the minimum voltage drop across laser drive DAC 430, power is wasted. The feedback from detector 460 to programmable switching power supply 110 is used to ensure that an adequate voltage drop occurs across laser drive DAC 430 without wasting power by having the power supply voltage too large.

In some embodiments, laser drive DAC 430 includes internal feedback to compensate for current variations. For example, the functionality provided by resistor 150 and amplifier 120 (FIGS. 1-3) may be provided by components internal to laser drive DAC 430.

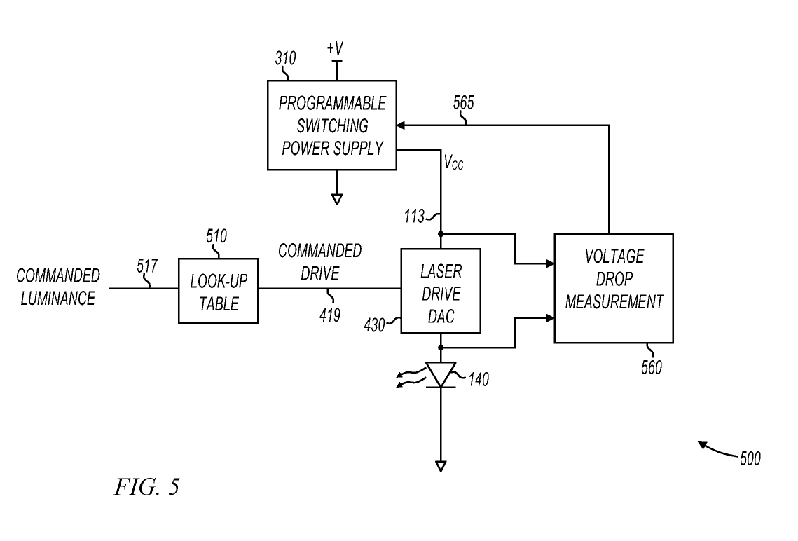

FIG. 5 shows a laser drive amplifier apparatus with a voltage drop measurement circuit. Apparatus 500 includes programmable switching power supply 310, laser drive DAC 430, and laser diode 140, all of which are described above with reference to earlier figures. Apparatus also includes look-up table 510 and voltage drop measurement circuit 560.

In operation, look-up table 510 converts a commanded luminance value on node 517 to a commanded drive value on node 419. The commanded luminance value represents the desired light output, and the commanded drive value represents the amount of current needed in laser diode 140 to obtain the desired luminance. Look-up table 510 may be implemented with any suitable circuit element, including a digital memory device. The contents of look-up table 510 may be determined during a calibration procedure, or may be continuously updated using a feedback mechanism (not shown).

Voltage drop measurement circuit 560 measures a voltage drop across laser drive DAC 430, and commands programmable switching power supply 310 to modify the output voltage V_{CC} on node 113. In some embodiments, voltage drop measurement circuit 560 provides a control signal to programmable switching power supply 310 on node 565.

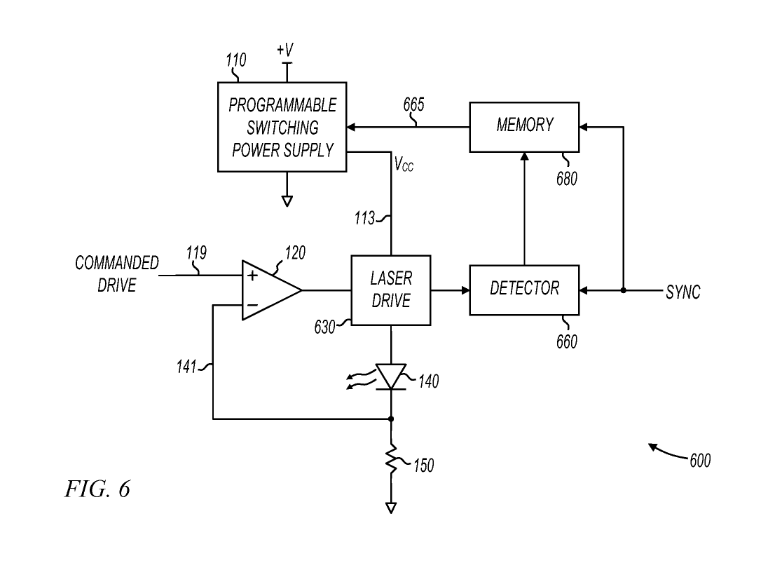

FIG. 6 shows a laser drive amplifier apparatus with memory. Apparatus 600 includes programmable switching power supply 110, amplifier 120, laser diode 140, and resistor 150, all of which are described above with reference to earlier figures. Apparatus 600 also includes laser drive circuit 630, detector 660, and memory 680.

Laser drive circuit 630 may be any type of laser drive circuit suitable for providing current to laser diode 140. Laser drive circuit 630 provides a drive current to laser diode 140 in response to the voltage provided by amplifier 120 and the power supply voltage on node 113. In some embodiments, laser drive circuit 630 includes a Class A amplifier transistor, such as transistor 130 (FIG. 1).

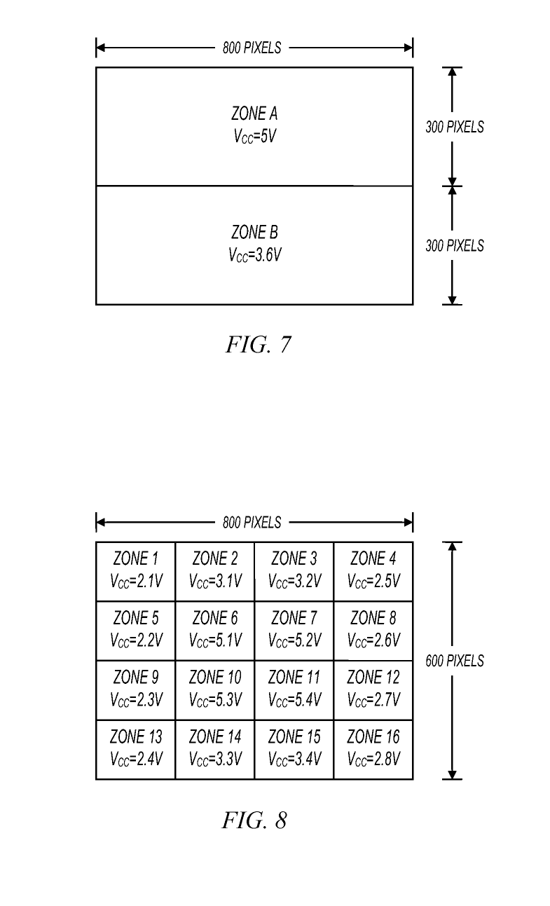

Detector 660 detects one or more voltages present in laser drive circuit 630. For example, detector 660 may detect an emitter voltage V_{EE}, or a collector-to-emitter voltage V_{CE}. In some embodiments, detector 660 detects a peak emitter voltage V_{P} over a time period and provides the peak emitter voltage information to memory 680. The period may be related to a video frame or video line, and may be controlled by the SYNC signal shown in FIG. 6. Memory 680 provides the peak voltage V_{P} information to programmable switching power supply 110 on node 665 in a manner that allows a video display to be divided into “zones” in which different power supply voltages may be used. Examples of display zones are shown in FIGS. 7 and 8.

FIGS. 7 and 8 show display areas having zones. In some embodiments, the display is divided into multiple zones and an appropriate switching supply voltage V_{CC} is selected for each zone. In a simple example shown in FIG. 7, the display is divided into two zones. In the case of an 800×600 display, each zone might be an 800×300 pixel array. As each zone is traversed, the maximum peak value is collected and retained using either an analog or digital memory device (see FIG. 6). During the successive frame, this zone data is used to program the programmable switching power supply's output voltage according to the video driver's peak requirement within that zone. FIG. 7 shows two example zones, zone A and zone B with example power supply voltages of 5V and 3.6V, respectively.

In a more complex example, the display might be divided into a two dimensional matrix, such as the 4×4 matrix shown in FIG. 8. Increasing the number of zones increases the opportunity for power reduction. In the limit, each pixel could be its own zone but such an implementation would require the programmable switching power supply to update at the pixel rate. In a practical system, the zone design is a compromise between the programmable switching power supply's tracking rate and the desired power reduction of the system.

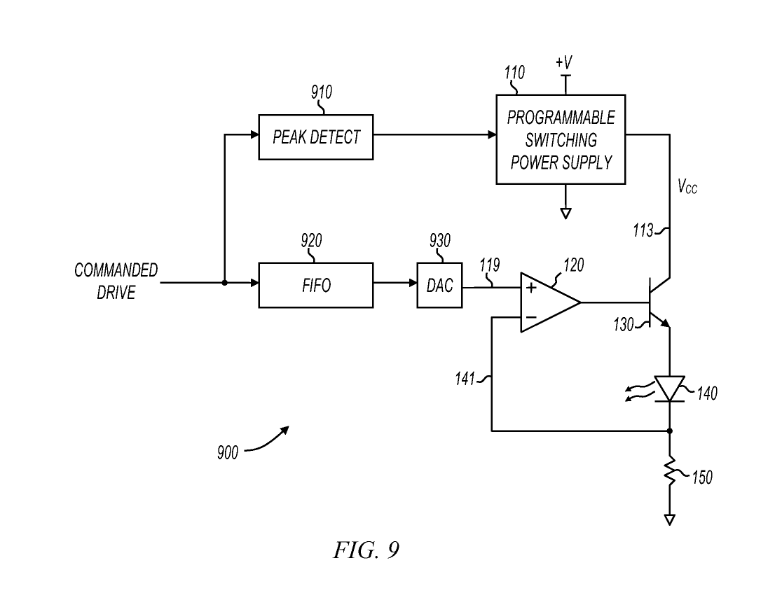

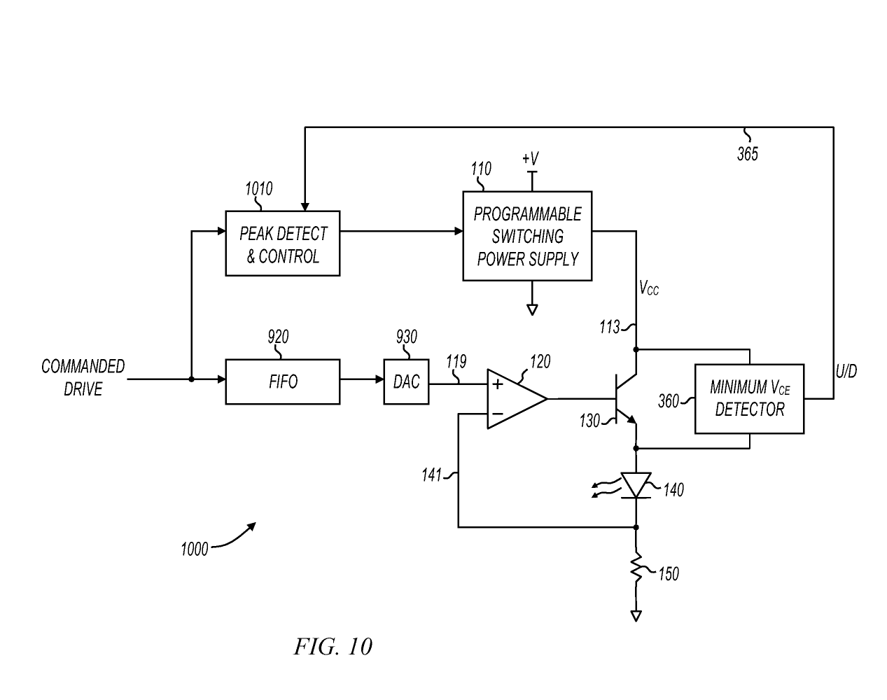

In an 800×600 pixel display, divided into the 4×4 matrix shown below, each zone is active for a window of about 5.5 us. The switching power supply must be able to track the zone dependent voltage requirement. A look-ahead system might be implemented in which the switching supply looks ahead to the next zone. If the next zone requires a higher voltage than the current zone, the switching supply should begin ramping up the voltage in preparation for the higher voltage requirement. If the next zone has a lower voltage requirement, no action is required. When transitioning from zone to zone, the switching supply should output the larger voltage requirement of the two zones. Various look-ahead systems are described below with reference to FIGS. 9 and 10.

In some embodiments, there may be a known relationship between time and Is peak power. For example, in some display devices, the peak power (i.e. maximum possible intensity) always occurs at the horizontal center of the display where the horizontal sweep velocity is the fastest. In other words, the maximum possible intensity is a function of the horizontal phase. An intelligent controller could use this phase information to modulate the output voltage of the switching supply. In addition, such a controller might incorporate the phase information into a peak detector to produce a phase-adjusted peak value. For example, a peak V_{EE} value of 2 Volts occurring at the left edge of the display might equate to a peak V_{EE} value of 4 Volts occurring the middle. In either case, it may be desirable to output a V_{P} value of 4 Volts indicating the peak value relative to the display center. Any of the embodiments disclosed herein may include phase information when commanding the programmable switching power supply to modify the power supply voltage.

FIG. 9 shows a laser drive amplifier apparatus with a First-In-First-Out (FIFO) memory. Apparatus 900 includes programmable switching power supply 110, Class A amplifier transistor 130, amplifier 120, laser diode 140, and resistor 150, all of which are described above with reference to earlier figures. Apparatus 900 also includes FIFO memory 920, digital-to-analog converter (DAC) 930, and peak detector circuit 910.

Peak detector circuit 910 and FIFO memory 920 both receive digital commanded drive values. While FIFO memory 920 delays the commanded drive values, peak detector circuit 910 digitally determines a peak value and commands programmable switching power supply 110 to output a power supply voltage. This allows peak detector circuit 910 to identify peak video codes prior to their amplification in the Class A amplifier, thereby allowing the power supply voltage to be continually adjusted to appropriate levels. For example, if the power supply is currently outputting a low voltage corresponding to dark video content, and a bright video pixel has just entered the FIFO, peak detector circuit 910 can begin to ramp up the power supply's voltage in time for the bright pixel's arrival at the amplifier. Seeing no additional bright pixels entering the FIFO, the digital controller can allow the power supply output to decay to a lower level.

In some embodiments, peak detector circuit 910 tracks the peak drive value on a pixel by pixel basis and updates the command to the power supply as needed. In these embodiments, even though the command to the power supply is continuously updated, the response time of the power supply may be limited by other design factors. In other embodiments, peak detector circuit 910 detects the peak commanded drive value within a zone, and updates the command to the power supply at zone boundaries. A zone may be a single video line or less than a line of video. A zone may also be a fragment of a display area such as those shown in FIGS. 7 and 8.

FIG. 10 shows a laser drive amplifier apparatus with a FIFO memory and a minimum voltage detector. Apparatus 1000 includes all of the components shown in FIG. 9 and also includes minimum V_{CE} detector 360 which feeds back information to peak detector and control circuit 1010. In embodiments represented by FIG. 9, the peak value is digitally determined before the video is sent to the video amplifier. However, since the laser diode's characteristics vary with process, temperature and age, it may be desirable to incorporate some feedback mechanism that insures that sufficient regulator margin is always maintained. For example, if the maximum video code in a zone is 185 and equates to a laser diode current of 200 mA, the supply voltage required to drive the laser diode to this level is a function of the laser diode itself and will vary from device to device. The required supply voltage V_{CC} might range from 2 to 4 Volts, depending on the laser diode.

In embodiments represented by FIG. 10, since peak detector and control circuit 1010 has commanded the power supply output voltage (V_{CC}) and knows the maximum video level during any time period (e.g. one zone), it can use the U/D output from minimum V_{CE} detector 360 to adjust V_{CC} over time. For example, if during the time period of one line of video, the maximum video code is 185 and the control circuit commands the switching supply to output some voltage V₁, and the U/D flag toggles to indicate that V_{CE} dropped below 0.5 Volts, the control circuit will increase the digital command for video code 185 by some minimum increment for the next video line in which video code 185 is the maximum code. Similarly, if the U/D flag does not toggle, the control circuit will decrease the digital command for video code 185. The control circuit continually adjusts V_{CC} for every “maximum” video code, increasing and decreasing V_{CC} around the ideal voltage level.

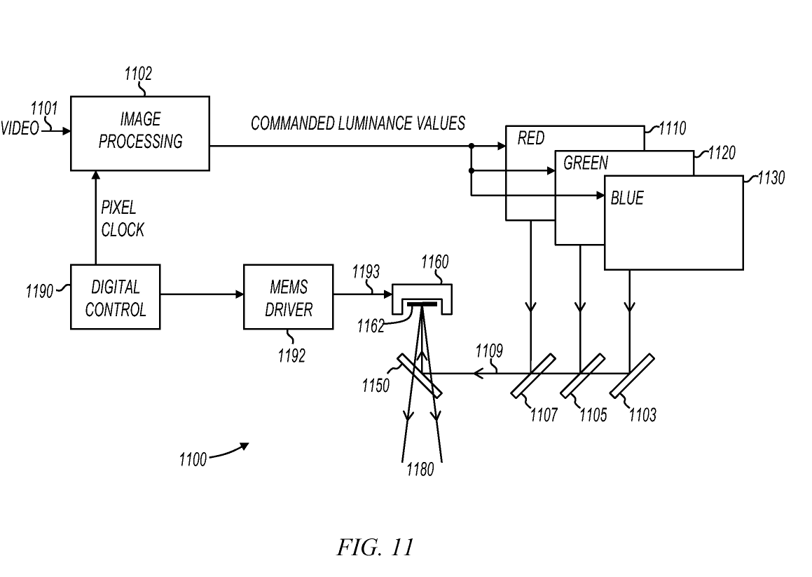

FIG. 11 shows a color laser projection apparatus. System 1100 includes image processing component 1102, laser light sources 1110, 1120, and 1130. Projection system 1100 also includes mirrors 1103, 1105, and 1107, filter/polarizer 1150, micro-electronic machine (MEMS) device 1160 having mirror 1162, MEMS driver 1192, and digital control component 1190.

In operation, image processing component 1102 receives video data on node 1101, receives a pixel clock from digital control component 1190, and produces commanded luminance values to drive the laser light sources when pixels are to be displayed. Image processing component 1102 may include any suitable hardware and/or software useful to produce color luminance values from video data. For example, image processing component 1102 may include application specific integrated circuits (ASICs), one or more processors, or the like.

Laser light sources 1110, 1120, and 1130 receive commanded luminance values and produce light. Laser light sources 1110, 1120, and 1130 may include any of the laser drive amplifier apparatus described herein. For example, laser light sources 1110, 1120, and 1130 may include any of apparatus 100 (FIG. 1), 200 (FIG. 2), 300 (FIG. 3), 400 (FIG. 4), 500 (FIG. 5), 600 (FIG. 6), 900 (FIG. 9), or 1000 (FIG. 10).

Each light source produces a narrow beam of light which is directed to the MEMS mirror via guiding optics. For example, blue laser light source 1130 produces blue light which is reflected off mirror 1103 and is passed through mirrors 1105 and 1107; green laser light source 1120 produces green light which is reflected off mirror 1105 and is passed through mirror 1107; and red laser light source 1110 produces red light which is reflected off mirror 1107. At 1109, the red, green, and blue light are combined. The combined laser light is reflected off filter/polarizer 1150 on its way to MEMS mirror 1162. The MEMS mirror rotates on two axes in response to electrical stimuli received on node 1193 from MEMS driver 1192. After reflecting off MEMS mirror 1162, the laser light passes through filter/polarizer 1150 to create an image at 1180.

The MEMS based projector is described as an example application, and the various embodiments of the invention are not so limited. For example, the laser drive amplifier apparatus described herein may be used with other optical systems without departing from the scope of the present invention.

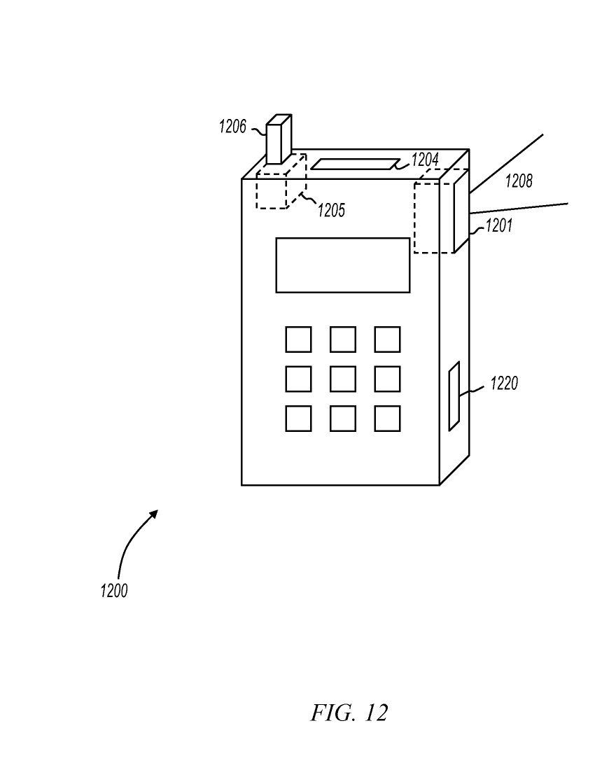

FIG. 12 shows a mobile device in accordance with various embodiments of the present invention. Mobile device 1200 may be a hand held projection device with or without communications ability. For example, in some embodiments, mobile device 1200 may be a handheld projector with little or no other capabilities. Also for example, in some embodiments, mobile device 1200 may be a device usable for communications, including for example, a cellular phone, a smart phone, a personal digital assistant (PDA), a global positioning system (GPS) receiver, or the like. Further, mobile device 1200 may be connected to a larger network via a wireless (e.g., WiMax) or cellular connection, or this device can accept data messages or video content via an unregulated spectrum (e.g., WiFi) connection.

Mobile device 1200 includes scanning projection device 1201 to create an image with light 1208. Similar to other embodiments of projection systems described above, mobile device 1200 may include a projector with one or more laser drive amplifier apparatus described above.

In some embodiments, mobile device 1200 includes antenna 1206 and electronic component 1205. In some embodiments, electronic component 1205 includes a receiver, and in other embodiments, electronic component 1205 includes a transceiver. For example, in global positioning system (GPS) embodiments, electronic component 1205 may be a GPS receiver. In these embodiments, the image displayed by scanning projection device 1201 may be related to the position of the mobile device. Also for example, electronic component 1205 may be a transceiver suitable for two-way communications. In these embodiments, mobile device 1200 may be a cellular telephone, a two-way radio, a network interface card (NIC), or the like.

Mobile device 1200 also includes memory card slot 1204. In some embodiments, a memory card inserted in memory card slot 1204 may provide a source for video data to be displayed by scanning projection device 1201. Memory card slot 1204 may receive any type of solid state memory device, including for example, Multimedia Memory Cards (MMCs), Memory Stick DUOs, secure digital (SD) memory cards, and Smart Media cards. The foregoing list is meant to be exemplary, and not exhaustive.

Mobile device 1200 also includes data connector 1220. In some embodiments, data connector 1220 can be connected to one or more cables to receive analog or digital video data for projection by scanning projection device 1201. In other embodiments, data connector 1220 may mate directly with a connector on a device that sources video data.

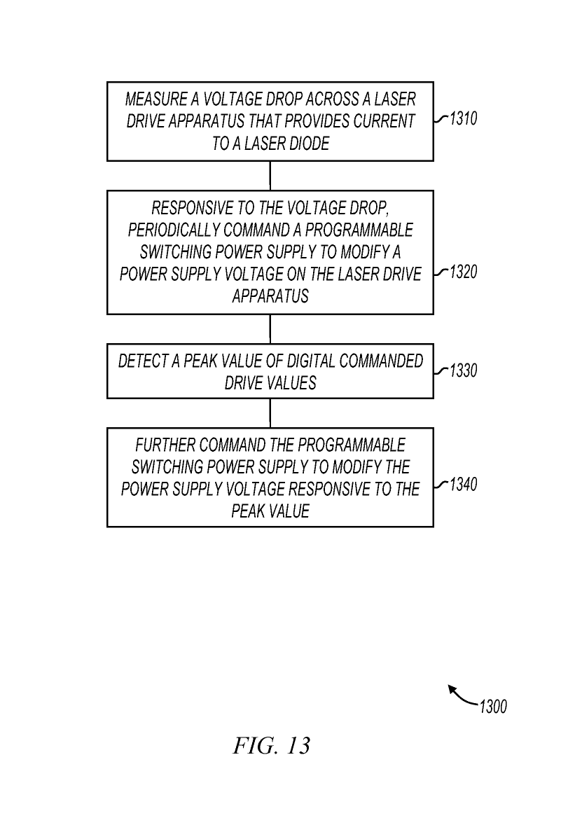

FIG. 13 shows a flowchart in accordance with various embodiments of the present invention. In some embodiments, method 1300, or portions thereof, is performed by a laser drive amplifier apparatus, a mobile projector, or the like, embodiments of which are shown in previous figures. In other embodiments, method 1300 is performed by an integrated circuit or an electronic system. Method 1300 is not limited by the particular type of apparatus performing the method. The various actions in method 1300 may be performed in the order presented, or may be performed in a different order. Further, in some embodiments, some actions listed in FIG. 13 are omitted from method 1300.

Method 1300 is shown beginning with block 1310 in which a voltage drop across a laser drive apparatus is measured. The laser drive apparatus is configured to drive a laser diode. This may correspond to the operation of minimum V_{CE} detector 360 (FIGS. 3, 10), voltage drop measurement circuit 560 (FIG. 5), or the like.

At 1320, a programmable switching power supply is commanded to modify a power supply voltage on the laser drive apparatus in response to the measured voltage drop. The operations of blocks 1310 and 1320, taken together, correspond to the operation of apparatus 300 (FIG. 3) and/or apparatus 500 (FIG. 5).

At 1330, a peak value of digital commanded drive values is detected. In some embodiments, this corresponds to the operation of peak detector and control circuit 1010 (FIG. 10). At 1340, the programmable switching power supply is commanded to further modify the power supply voltage in response to the peak value determined at 1330. The operations of blocks 1310, 1320, 1330, and 1340, taken together, correspond to the operation of apparatus 1000 (FIG. 10).

Although the present invention has been described in conjunction with certain embodiments, it is to be understood that modifications and variations may be resorted to without departing from the scope of the invention as those skilled in the art readily understand. Such modifications and variations are considered to be within the scope of the invention and the appended claims.

1. An apparatus comprising:
a laser diode to produce light in response to a current;
a transistor coupled to the laser diode to provide the current;
a voltage detector coupled to detect an emitter voltage on the transistor; and
a programmable switching power supply responsive to the voltage detector.

2-5. (canceled)

6. The apparatus of claim 1 wherein the voltage detector is operable to measure a collector-to-emitter voltage (V_{CE}).

7. The apparatus of claim 6 wherein the voltage detector is operable to command the programmable switching power supply to increase an output voltage when the collector-to-emitter voltage is below a threshold.

8-11. (canceled)

12. An apparatus comprising:
a laser diode to produce laser light in response to a current;
a bipolar junction transistor coupled to provide the current to the laser diode;
a voltage detector to measure a collector-to-emitter voltage (VCE) across the bipolar junction transistor; and
a programmable switching power supply coupled to provide a power supply voltage to the bipolar junction transistor in response to a signal provided by the voltage detector.

13. The apparatus of claim 12 wherein the voltage detector is operable to update the signal provided to the programmable switching power supply on a time interval related to a video frame.

14. The apparatus of claim 12 wherein the voltage detector is operable to update the signal provided to the programmable switching power supply on a time interval related to a video line.

15. The apparatus of claim 12 wherein the voltage detector is operable to command the programmable switching power supply to increase the power supply voltage when the collector-to-emitter voltage drops below a threshold.

16. An apparatus comprising:
a laser diode to produce laser light in response to a current;
a laser drive apparatus to drive the laser diode with the current;
a voltage drop measurement circuit coupled to measure a voltage drop across the laser drive apparatus; and
a programmable switching power supply coupled to provide a power supply voltage to the laser drive apparatus, wherein the programmable switching power supply is coupled to be responsive to the voltage drop measured across the laser drive apparatus.

17. The apparatus of claim 16 wherein the laser drive apparatus comprises a digital-to-analog converter (DAC).

18. The apparatus of claim 16 wherein the laser drive apparatus comprises a Class A amplifier transistor.

19. The apparatus of claim 16 wherein the voltage drop measurement circuit is operable to produce a control signal in response to a smallest measured voltage drop.

20. A mobile device comprising:
a communications transceiver; and
a projection apparatus that includes a MEMS mirror to scan laser light on two axes, and at least one laser light source to produce the laser light, the laser light source having a laser drive apparatus, a laser diode coupled to the laser drive apparatus, a minimum voltage detector to measure a voltage drop across the laser drive apparatus; and a programmable switching power supply to provide a power supply voltage to the laser drive apparatus, the programmable switching power supply being responsive to the minimum voltage detector.

21. The mobile device of claim 20 wherein the laser drive apparatus comprises a bipolar junction transistor.

22. The mobile device of claim 20 wherein the laser drive apparatus comprises a digital-to-analog converter (DAC).

23. A method comprising:
measuring a voltage drop across a laser drive apparatus coupled to source current to a laser diode; and
responsive to the voltage drop, commanding a programmable switching power supply to modify a power supply voltage on the laser drive apparatus.

24. The method of claim 23 wherein commanding a programmable switching power supply comprises commanding the programmable switching power supply periodically where the period is related to a video frame.

25. (canceled)
